(19) United States
(12) Patent Application Publication
(10) Pub. No.: US 2023/0213473 A1
(43) Pub. Date: Jul. 6, 2023

(54) SENSOR ELEMENT HAVING FOUR CONTACT SURFACES AND THREE VIAS

(71) Applicant: Robert Bosch GmbH, Stuttgart (DE)

(72) Inventors: Andreas Bigge, Stegaurach (DE); Annette Hanselmann, Stuttgart (DE); Martin Heyer, Stuttgart (DE); Martin Eckardt, Stuttgart (DE); Thomas Pastuszka-Lude, Stuttgart (DE); Thomas Kraus, Buttenheim (DE); Tobias Rentrop, Stuttgart (DE); Ulrich Arneth, Stegaurach (DE)

(21) Appl. No.: 17/998,581

(22) PCT Filed: Jun. 14, 2021
(86) PCT No.: PCT/EP2021/065892

§ 371 Date: Nov. 11, 2022

(30) Foreign Application Priority Data
Jun. 25, 2020 (DE) 10 2020 207 877.7

(51) Int. Cl. G01N 27/407; G01N 27/406; G01N 27/409

(52) U.S. Cl. CPC G01N 27/4071; G01N 27/4067; G01N 27/409

(57) ABSTRACT

A ceramic planar sensor element having four contact surfaces and three vias, for example for a lambda sensor. Measures are provided for increasing the loadability of the sensor element in relation to mechanical stresses. The measures relate in particular to the arrangement of the vias and to the design of insulating layers in the interior of the sensor element.

### BACKGROUND INFORMATION

Ceramic sensor elements for lambda sensors are described, for example, in German Patent Application No. DE 10 2018 206 966 A1, which sought to increase the loadability of the sensor element in relation to mechanical stresses.

### SUMMARY

The present invention also aims to increase the loadability of the sensor element in relation to mechanical stresses.

In this context, the inventors found, firstly, that in a ceramic sensor element, a certain mechanical weakening in the end region of the sensor element facing away from the exhaust gas already results in principle from the provision of the first, second and third via.

Moreover, the inventors found that the mechanical weakening also occurs when the vias are close together. In this case, the individual weakening caused by each of the vias is further increased in total.

Moreover, the inventors found that the mechanical weakening also occurs when one or more vias in the transverse direction are close to an outer edge of the sensor element. In this case, the sensor element offers only limited resistance to a mechanical stress originating from the outer edge of the sensor element.

Moreover, the inventors found that the mechanical weakening also occurs when a via is spaced relatively far from the axial end of the sensor element facing away from the exhaust gas.

Specifically, in this case, forces acting in the layer direction on the axial end of the sensor element facing away from the exhaust gas give rise to a sizeable lever effect in the region of the via, resulting in high mechanical stresses at that point.

The inventors also found that a further general mechanical weaking may originate from insulating layers arranged between the solid electrolyte layers, partly because these layers already fundamentally disrupt the homogeneous layer structure formed by solid electrolyte layers. In addition, by reason of the differing sintering behavior of the insulating layers and the solid electrolyte layers, the incorporation of the insulating layers leads to mechanical stresses.

The inventors found that this is particularly the case when the insulating layers extend to close to the outer edges of the sensor element in the transverse direction or in the axial direction.

The inventors then found various possibilities for reducing or minimizing this mechanical weakening overall. These possibilities are each effective in themselves and especially so when combined.

According to an example embodiment of the present invention, it is provided a that in a sensor element, the second via and the third via are both arranged on the exhaust gas side of the first via in the axial direction and that the first via is arranged between the second via and the third via in the transverse direction. In comparison to the arrangement described in the related art, it is possible in this way to increase the distance between the vias without having to position the vias excessively far from the axial end of the sensor element facing away from the exhaust gas. Furthermore, the distance between the first via and the outer edge of the sensor element in the transverse direction is increased.

This is all the more the case if the second via and the third via are positioned at the same axial level and if the first via is positioned centrally between the second via and the third via in the transverse direction, such that the first, second and third vias are located at the corners of an isosceles triangle, especially if in the isosceles triangle the angle opposite the base is not greater than 90° and not less than 30°. The triangle may preferably be an equilateral triangle, for example.

In the context of the present invention, the position of a via and, consequently, relative positions of vias in respect of one another, may be specified starting from the position of the centroid of the via in plan view of a large face of the sensor element. In the case of vias that in plan view of a large face of the sensor element are circular, this position would thus be the center point of the respective circle.

In addition or alternatively, it may be provided in the case of a sensor element according to the present invention that the first via, the second via and the third via are positioned entirely in the end region of the sensor element facing away from the exhaust gas, the extent of the end region of the sensor element facing away from the exhaust gas in the axial direction being less than one-fifth of the extent of the sensor element in the axial direction. By reason of the reduced lever effect, forces acting in the layer direction on the axial end of the sensor element facing away from the exhaust gas then bring about only reduced stresses in the region of the via.

It may be provided that the first via is designed as a first hole in the first solid electrolyte layer with a first conductive material arranged in the first hole, and that the second via is designed as a second hole in the second solid electrolyte layer with a second conductive material arranged in the second hole, and that the third via is designed as a third hole in the second solid electrolyte layer with a third conductive material arranged in the third hole, and that the first hole has a first diameter and the second hole has a second diameter and the third hole has a third diameter.

In plan view of a large face of the sensor element, the holes may be circular, for example, such that the diameters of the holes are the diameters of the respective circles. The three diameters in question may be the same size, for example.

It may be provided that, in plan view of the large faces of the sensor element, the centroid of the second hole is spaced a distance a from the centroid of the third hole.

If in a sensor element having the features of the present invention, it is provided that the distance a is less than the sum of the second diameter and the third diameter, and/or if it is provided that the half-distance is less than the distance from the centroid of the second hole to a closest outer edge of the sensor element in the transverse direction, and/or if it is provided that the half-distance is less than the distance from the centroid of the third hole to the closest outer edge of the sensor element in the transverse direction, then the distance between the second and the third via and relative to a distance from the vias to an outer edge of the sensor element and relative to the hole diameters overall is in a balanced and in that sense mechanically optimized range.

If, in a sensor element according to the present invention, it is provided that the distance from the centroid of the first hole in the axial direction to the first, second, third and/or fourth contact surface is no greater than half the diameter of the first hole, this means that the first hole is arranged very close to the contact surfaces in the axial direction and hence close to the end of the sensor facing away from the exhaust gas. By reason of the reduced lever effect, forces acting in the layer direction on the axial end of the sensor element facing away from the exhaust gas then bring about only reduced stresses in the region of the first via.

In addition or alternatively, it may be provided that, in plan view of the large face of the sensor element, the first contact surface has a concave outer contour facing the first via. The first via may then be moved especially close to the end of the sensor element facing away from the exhaust gas without coming into contact with the first contact surface, especially if it is provided that the concave outer contour has a radius that is equal to half the diameter of the first hole or differs from half the diameter of the first hole by no more than 50%. In addition or alternatively, the first via and the concave outer contour of the first contact surface may also be concentric with each other.

In addition or alternatively, in a sensor element according to an example embodiment of the present invention, it may be provided that, between the first and the second solid electrolyte layer, an insulating layer is arranged or a plurality of insulating layers are arranged in such a way that a first electrical network, comprising the second electrode, the second trace and the first via, is electrically isolated by the insulating layer/insulating layers from a second electrical network, comprising the resistive heater trace, the third trace, the fourth trace, the second via and the third via.

It may be provided in this case that, in plan view of the large faces of the sensor element, the extent of the insulating layer/insulating layers is only as large as is necessary in order to electrically isolate the first electrical network from the second electrical network and, in addition, the insulating layer/insulating layers is/are surrounded by a sealing frame/by respective sealing frames made of solid electrolyte material. “Only” in this context may assume in particular that, for manufacturing reasons, the insulating layer/insulating layers extend in the transverse direction and/or in the axial direction beyond the entirety of the structure to be insulated, for example by up to 250 μm and/or by up to 5% of the extent of the sensor element in the transverse direction—but no more—beyond the structure to be isolated. The mechanical weakening of the sensor element is then reduced to a minimum that is unavoidable for the desired electrical isolation.

A comparable technical effect results from the measure whereby the extent of the sealing frame/of all sealing frames in the transverse direction, measured from the associated insulating layer to the outer edge of the sensor element in the end region of the sensor element facing away from the exhaust gas, is always greater than 1/10 of the extent of the sensor element in the transverse direction.

The solid electrolyte material, like the material of the solid electrolyte layers, may be YSZ or the like.

According to an example embodiment of the present invention, advantageously, both a first insulating layer and a second insulating layer may be provided, the first insulating layer being arranged on the side facing the first solid electrolyte layer and the first electrical network, viewed from the second insulating layer in the layer direction, and the second insulating layer being arranged on the side facing the second solid electrolyte layer and the second electrical network, viewed from the first insulating layer in the layer direction.

It may be provided in this case that the first insulating layer, in plan view of the large face of the sensor element, covers the second trace and the first, second and third via, the first insulating layer widening in the transverse direction at the axial level of the second and third via for this purpose, and/or that the second insulating layer, in plan view of the large face of the sensor element, encloses the second electrical network and additionally covers the first via, in that the second insulating layer narrows in the transverse direction at the axial level of the first via. The desired electrical isolation effect occurs in these cases with just a minimal mechanical weakening of the sensor element, in other words with retention of an optimized mechanical stability of the sensor element.

### BRIEF DESCRIPTION OF THE DRAWINGS

FIG. 1 shows a schematic view of the outlines of a ceramic sensor element, according to an example embodiment of the present invention.

FIGS. 2A-2F show layer planes of the ceramic sensor element from FIG. 1.

### DETAILED DESCRIPTION OF EXAMPLE EMBODIMENTS

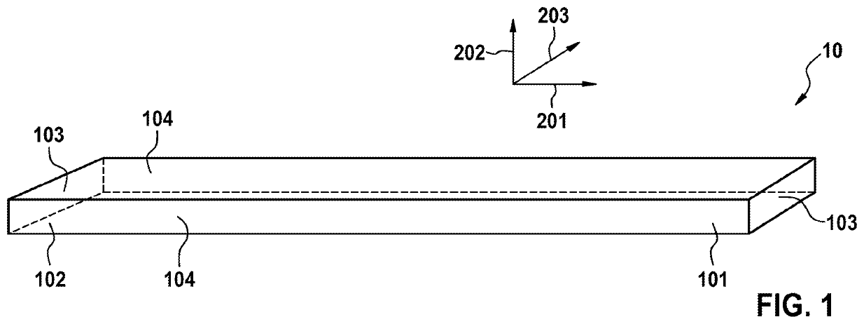

FIG. 1 shows a schematic view of the basic form of a planar ceramic sensor element 10. It has an axial end region 101 facing the exhaust gas and axially opposite thereto an axial end region 102 facing away from the exhaust gas. It has a cuboidal basic form with two smallest side faces 103, two largest side faces 104 (also: large faces 104), smallest side faces 103 being aligned at right angles to axial direction 201 and largest side faces 104 being aligned at right angles to a layer direction 202, a transverse direction 203 being oriented at right angles to axial direction 201 and at right angles to layer direction 202. The extent of the sensor element in transverse direction 203 is 5 mm, for example.

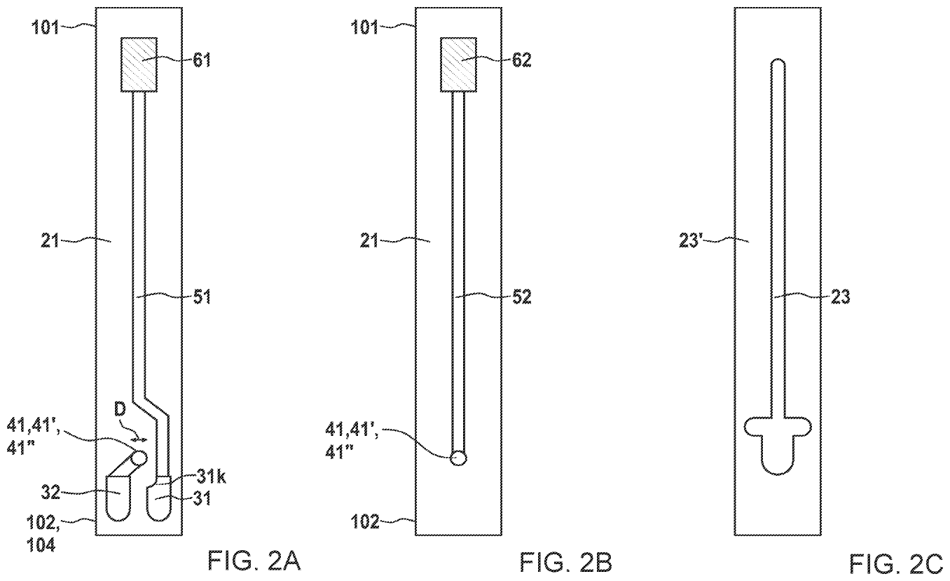

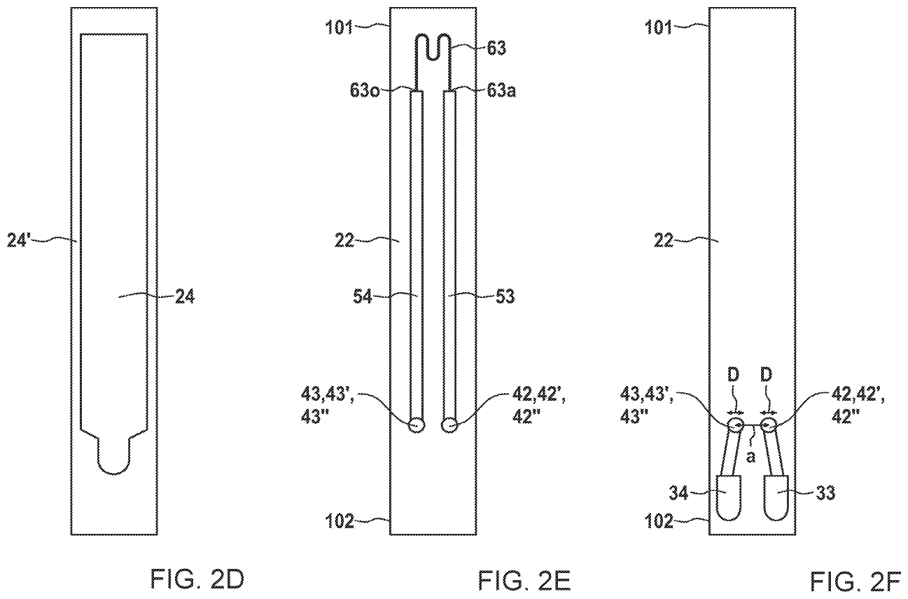

FIGS. 2A-2F show individual views that make up the sensor element 10 shown in FIG. 1. The representation is consistently in plan view of largest side faces 104, corresponding to a viewing direction in FIG. 1 from top to bottom.

FIG. 2A shows the upper side of a first solid electrolyte layer 21 arranged at the top in FIG. 1. In end region 102 facing away from the exhaust gas, on the upper side of first solid electrolyte layer 21, a first contact surface 31 and a second contact surface 32 are arranged side by side in the transverse direction at the same axial level.

On the upper side of first solid electrolyte layer 21, first contact surface 31 is connected by way of a first trace 51 to a first electrode 61, which is arranged in end region 101 of sensor element 10 facing the exhaust gas.

Second contact surface 32 is electrically conductively connected to a first via 41, which is arranged centrally in transverse direction 203 with respect to sensor element 10, a short axial distance from first and second contact surface 31, 32. First via 41 is, for example, a cylindrical first hole 41′ which passes through first solid electrolyte layer 21 and which contains in its interior—optionally electrically isolated from first solid electrolyte layer 21—a first conductive material 41″. The diameter D of the first hole is 1 mm, for example.

In axial direction 201, first via 41 is, for example, 5 mm away from the end of sensor element 10 facing away from the exhaust gas.

A corner of first contact surface 31 facing first via 41 is designed as a circular recess, such that first contact surface 31 has a concave outer contour 31k here. Concave outer contour 31k is designed as a circular arc, in the example an arc with a radius of curvature of 0.5 mm about 90°. Thus, even in the event of manufacturing-related variations in the precise arrangement of the components, the possibility of an electrical short circuit between first via 41 and first contact surface 31 is excluded.

FIG. 2B shows the underside of first solid electrolyte layer 21 arranged at the top in FIG. 1. Via 41 starting from the upper side of first solid electrolyte layer 21 leads to this layer plane. On this underside, via 41 is electrically conductively connected by way of second trace 52 to second electrode 62, which is arranged in end region 101 of sensor element 10 facing the exhaust gas, in the interior thereof.

First electrode 61, which is exposed to the exhaust gas, together with first solid electrolyte layer 21 and second electrode 62, which is not exposed to the exhaust gas, forms an electrochemical Nernst cell with which—assuming appropriate heating, see below—on the basis of a Nernst voltage developing at said cell and measurable between first and second contact surface 31, 32, it may be determined whether the exhaust gas is the result of a combustion with excess oxygen (“lean”) or of a combustion with excess fuel (“rich”) or of a combustion in which oxygen and fuel are in stoichiometric equilibrium.

FIG. 2F shows the underside of second solid electrolyte layer 22 arranged at the bottom in FIG. 1. In end region 102 facing away from the exhaust gas, on the underside of second solid electrolyte layer 22, a third contact surface 33 and a fourth contact surface 34 are arranged side by side in the transverse direction. Third contact surface 33 and fourth contact surface 34 are arranged at the same axial level of sensor element 10 in respect of first contact surface 31 and second contact surface 32.

Third contact surface 33 is electrically conductively connected to a second via 42, which is arranged, for example, at an axial distance of 7.2 mm from the end of sensor element 10 facing away from the exhaust gas. Second via 42 is arranged 0.95 mm off center, for example, in the transverse direction (to the right in FIG. 2F). The distance therefrom in transverse direction 203 to the outer edge of sensor element 10 is thus 1.55 mm.

Symmetrically thereto once again, fourth contact surface 34 is electrically conductively connected to a third via 43, which is arranged at the same axial level and is equally off-centered in the transverse direction (albeit to the left rather than the right) as second via 42.

Second and third via 42, 43 are, for example, cylindrical second and third holes 42′, 43′ which pass through second solid Substitute Specification electrolyte layer 22 and which contain in their interior—optionally electrically isolated from second solid electrolyte layer 22—a second and a third conductive material 42″, 43″. The diameter D of these holes is in both cases 1 mm, for example.

FIG. 2E shows the upper side of second solid electrolyte layer 22 arranged at the bottom in FIG. 1. Vias 42, 43 starting from the underside of second solid electrolyte layer 22 lead to this layer plane. On this upper side they are electrically conductively connected by way of third trace 53 and fourth trace 54 to both ends 63a, 63o of a resistive heater trace 63, which is arranged in end region 101 of sensor element 10 facing the exhaust gas.

By applying an electrical voltage between third and the fourth contact surface 33, 34, resistive trace 63 heats up in such a way that the Nernst cell assumes the operating temperature necessary for the measuring function of sensor element 10.

To prevent undesirable electrical crosstalk between the heating function and the measuring function of sensor element 10, a first insulating layer 23 and a second insulating layer 24 are arranged between first solid electrolyte layer 21 and second solid electrolyte layer 22. First insulating layer 23 is positioned on the underside of first solid electrolyte layer 21 and second solid electrolyte layer [sic] is positioned on the upper side of second solid electrolyte layer 22.

Insulating layers 23, 24 consist, for example, of Al₂O₃ and in layer direction 202, for example, have a smaller extent than solid electrolyte layers 21, 22. For example, insulating layers 23, 24 may be screen-printed layers, while solid electrolyte layers 21, 22 may be formed from green ceramic films, for example.

First insulating layer 23 is shown in FIG. 2C. The form of the first insulating layer is such that it covers second trace 52 and first, second and third via 41, 42, 43 as exactly as possible, without projecting laterally beyond these elements more than is necessary for manufacturing reasons. To this end, first insulating layer 23 widens in transverse direction 203 at the axial level of second and third via 42, 43.

Second insulating layer 24 is shown in FIG. 2D. The form of second insulating layer 24 is such that it covers resistive heater trace 63, third and fourth trace 53, 54 and first, second and third via 41, 42, 43 as exactly as possible, without projecting laterally beyond these elements more than is necessary for manufacturing reasons. To this end, second insulating layer 24 narrows in transverse direction 203 at the axial level of first via 41.

1-16. (canceled)

17. A ceramic planar sensor element for a lambda sensor, the sensor element having an axial end region facing exhaust gas, and axially opposite to the axial end region facing the exhaust gas, an end region facing away from the exhaust gas, the sensor element having a cuboidal basic form with two smallest side faces, two largest side faces, the smallest side faces being aligned at right angles to an axial direction, the largest side faces being aligned at right angles to a layer direction, a transverse direction being oriented at right angles to the axial direction and at right angles to the layer direction, the ceramic sensor element having ceramic layers, which in the layer direction are arranged one on top of the other, the ceramic layers including at least one first and one second solid electrolyte layer, the ceramic sensor element having, in the axial end region facing the exhaust gas, a first electrode that is exposed to the exhaust gas, the ceramic sensor element having, in the axial end region facing the exhaust gas, in an interior, a second electrode that is separated from the exhaust gas, the first electrode together with the second electrode and together with the first solid electrolyte layer forming an electrochemical cell, an electrical resistive heater trace having a first end and a second end being arranged in an interior of the ceramic sensor element, in the axial end region facing the exhaust gas, exactly two contact surfaces for electrically contacting the sensor element from outside being arranged on each of the two largest side faces in the axial end region facing away from the exhaust gas, a first contact surface of the contact surfaces being connected to the first electrode by way of a first trace, a second contact surface of the contact surfaces being connected to the second electrode by way of a first via through the first solid electrolyte layer and by way of a second trace arranged in the interior of the sensor element, a third contact surface of the contact surfaces being connected to the first end of the resistive heater trace by way of a second via through the second solid electrolyte layer and by way of a third trace arranged in the interior of the sensor element, a fourth contact surface of the contact surfaces being connected to the second end of the resistive heater trace by way of a third via through the second solid electrolyte layer and by way of a fourth trace arranged in the interior of the sensor element,
wherein the second via and the third via are both arranged on the exhaust gas side of the first via in the axial direction and the first via is arranged between the second via and the third via in the transverse direction.

18. The sensor element as recited in claim 17, wherein the first via, the second via, and the third via are positioned entirely in the end region of the sensor element facing away from the exhaust gas, an extent of the end region of the sensor element facing away from the exhaust gas in the axial direction being less than one-fifth of an extent of the sensor element in the axial direction.

19. The sensor element as recited in claim 17, wherein the second via and the third via are positioned at the same axial level and the first via is positioned centrally between the second via and the third via in the transverse direction, such that the first, second and third vias are located at corners of an isosceles triangle.

20. The sensor element as recited in claim 19, wherein in the isosceles triangle, an angle opposite a base of the isosceles triangle is not greater than 90° and not less than 30°.

21. The sensor element as recited in claim 17, wherein the first via is configured as a first hole in the first solid electrolyte layer with a first electrically conductive material arranged in the first hole, and the second via is configured as a second hole in the second solid electrolyte layer with a second electrically conductive material arranged in the second hole, and the third via is designed as a third hole in the second solid electrolyte layer with a third electrically conductive material arranged in the third hole, and the first hole has a first diameter and the second hole has a second diameter and the third hole has a third diameter, and, in plan view of a large face of the sensor element, a centroid of the second hole is spaced a distance from a centroid of the third hole.

22. The sensor element as recited in claim 21, wherein the distance is less than a sum of the second diameter and the third diameter.

23. The sensor element as recited in claim 22, wherein a half-distance is less than a distance from the centroid of the second hole to a closest outer edge of the sensor element in the transverse direction and the half-distance is less than a distance from the centroid of the third hole to the closest outer edge of the sensor element in the transverse direction.

24. The sensor element as recited in claim 21, wherein a distance from the centroid of the first hole in the axial direction to the first and/or second and/or third and/or fourth contact surface is no greater than half the diameter of the first hole.

25. The sensor element as recited in claim 21, wherein, in plan view of the large face of the sensor element, the first contact surface has a concave outer contour facing the first via.

26. The sensor element as recited in claim 25, wherein the concave outer contour has a radius equal to half the diameter of the first hole.

27. The sensor element as recited in claim 17, wherein, between the first and the second solid electrolyte layer, an insulating layer is arranged or a plurality of insulating layers are arranged, in such a way that a first electrical network, including the second electrode, the second trace, and the first via, is electrically isolated by the insulating layer or the insulating layers, from a second electrical network, including the resistive heater trace, the third trace, the fourth trace, the second via, and the third via.

28. The sensor element as recited in claim 27, wherein, in plan view of large faces of the sensor element, an extent of the insulating layer or the insulating layers is only as large as is necessary in order to isolate the first electrical network from the second electrical network, and, the insulating layer or the insulating layers, is surrounded by a sealing frame or by respective sealing frames, made of solid electrolyte material.

29. The sensor element as recited in claim 28, wherein an extent of the sealing frame or of all sealing frames, in the transverse direction, measured from an associated insulating layer to an outer edge of the sensor element in the end region of the sensor element facing away from the exhaust gas, is always greater than 1/10 of an extent of the sensor element in the transverse direction (203).

30. The sensor element as recited in claim 27, wherein a first insulating layer is provided and a second insulating layer is provided, the first insulating layer being arranged on a side facing the first solid electrolyte layer and the first electrical network, viewed from the second insulating layer in the layer direction, and the second insulating layer being arranged on a side facing the second solid electrolyte layer and the second electrical network, viewed from the first insulating layer in the layer direction.

31. The sensor element as recited in claim 30, wherein the first insulating layer, in plan view of a large face of the sensor element, covers the second trace and the first, second and third via, the first insulating layer widening in the transverse direction at the axial level of the second and the third via for this purpose.

32. The sensor element as recited in claim 31, wherein the second insulating layer, in plan view of the large face of the sensor element, encloses the second electrical network and covers the first via, in that the second insulating layer narrows in the transverse direction at the axial level of the first via.
